(19) United States
(12) Patent Application Publication
(10) Pub. No.: US 2003/0169462 A1
(43) Pub. Date: Sep. 11, 2003

(54) System and method for managing network devices

(75) Inventors: Lorraine F. Barrett, Yorba Linda, CA (US); Stephen Sjolander, Laguna Niguel, CA (US)

Correspondence Address: Lorraine Barrett, Suite E, 15520 Rockfield Blvd., Irvine, CA, 92618, US

(73) Assignee: NETAPHOR SOFTWARE, INC.

(21) Appl. No.: 10/384,241

(22) Filed: Mar. 7, 2003

Related U.S. Application Data
(60) Provisional application No. 60/363,134, filed on Mar. 11, 2002.

(51) Int. Cl. H04N 1/024

(52) U.S. Cl. 358/473

(57) ABSTRACT

A system and method for managing network devices by providing status and configuration information for the networked devices via a handheld device. The system includes a means for identifying and categorizing managed network devices using a handheld device. Once discovered and identified the networked device is monitored for alerts based on a specific category. The networked device also provides basic configuration information that is viewed via the handheld device display.

### CROSS-REFERENCE TO RELATED APPLICATIONS

This application claims priority from U.S. Provisional Application Serial No. 60/363,134, filed Mar. 11, 2002, by Barrett et al, entitled “System and Method for Managing Network Devices”.

### STATEMENT REGARDING FEDERALLY SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

i) Field of the Invention

The present invention relates to methods and systems for categorizing and identifying managed network devices and systems.

ii) Description of Related Art

Handheld devices are portable computing devices that include personal digital assistants (“PDAs”), mobile phones and other similar devices (“collectively referred to herein as “handheld devices” or “PDAs”), are widespread in today's business and personal lives.

PDAs today may be connected to networks and network devices. However, PDAs have limited computing power and low memory storage space, and generally operate as “dumb” network terminals because they are used to receive information but cannot monitor and/or discover network devices.

Therefore, there is a need for a system and method that allows existing PDAs to manage network devices and peripherals.

SNMP information is known from J. Case et al., A Simple Network Management Protocol (SNMP), Network Working Group, RFC 1157, pp. 1-36, May 1990. MIB and OID information is known from M. Rose et al., Concise MIB Definitions, Network Working Group, RFC 1212, pp. 1-19, March 1991.

### BRIEF SUMMARY OF THE INVENTION

In one aspect of the present invention, a method is provided for a handheld device to discover and attain alert management information for networked devices. The method includes scanning the devices to retrieve information to facilitate categorization. The method also includes categorizing the devices; monitoring alerts specific to a category; and handling responses of each device.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

FIG. 1 is a diagram of a network architecture that may be used to implement the present invention.

FIG. 2 is a block diagram of a PDA system that may be used to execute computer executable process steps, according to one aspect of the present invention.

FIG. 3 is a block diagram showing the internal functional architecture of the system in FIG. 2.

FIG. 4 is a block diagram of a system for discovering, monitoring and sending alerts for network devices, according to one aspect of the present invention.

FIG. 5 shows sample standard management information base (“MIB”) codes for a printer.

FIG. 6 shows sample alert codes, according to one aspect of the present invention.

FIG. 7 is a flow diagram of executable process steps for scanning network devices, according to one aspect of the present invention.

FIG. 8 is a flow diagram of executable process steps for categorizing network devices, according to one aspect of the present invention.

FIG. 9 is a flow diagram of executable process steps for sending monitor requests to network devices, according to one aspect of the present invention.

FIGS. 10A-10B show a flow diagram of executable process steps for receiving responses from network devices, according to one aspect of the present invention.

Features appearing in multiple figures with the same reference numeral are the same unless otherwise indicated.

### DETAILED DESCRIPTION OF THE INVENTION

Definitions and Brief Description of Terms: The following definitions are used in various aspects of the present invention with respect to computer networks(but not exclusively):

“SNMP”: SNMP, Simple Network Management Protocol, is a network protocol that governs data transmission and reception, and is implemented in various networks. SNMP is a network management protocol. Software and firmware products designed for networks are often based on SNMP. SNMP is used to:

Monitor network printer queues

Set up addresses for network devices

Assign priorities for communication

Install software on a network

Manage databases

Manage power on the network

SNMP interacts with the management information bases (MIBs), defined below, of devices on the network. By issuing SNMP commands, a network manager can monitor and control the network by retrieving information from network devices and issuing control commands. SNMP also has the capability of handling traps, messages that alert the network management station of important events.

An SNMP based product is any device or application that communicates management information through the Simple Network Management Protocol. Devices that use SNMP can be monitored and managed with SNMP network management software.

“SNMP Agent”: is the software that runs on a device that implements the SNMP protocol. A network manager retrieves management information from, and sends management information to SNMP agents.

“SNMP TRAP”: SNMP Traps are used by network entities to signal abnormal conditions to management stations. SNMP traps enable an agent to notify the management station (like Ciscoview® or HP Open View®) of significant events by way of an unsolicited SNMP message. After receiving the event, a manager is alerted, and the manager may choose to take action based on the event. For instance, the network manager can poll the agent directly, or poll other associated device agents to get a better understanding of the event. SNMP requests are required for discovery and topology changes. To understand a trap sent to the network manager by an agent, the management system must know what the object identifier (OID) defines and it must have the “MIB” for that trap loaded.

“OID”: Object identifier values are used to name and describe numerous types of objects used in computer networks or otherwise.

“MIB”: A Management Information Base (MIB) describes the attributes of a managed resource in a way that an SNMP management system can understand. An SNMP MIB is written in Abstract Notation One (ASN.1) and formatted in conformity with the SNMP standards.

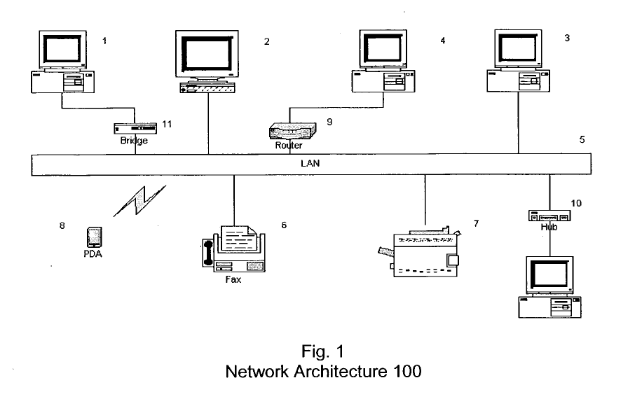

To understand the various adaptive aspects of the present invention, a brief description of a network, a PDA system and a block diagram of the internal architecture of the PDA system is provided with respect to FIGS. 1-3. Turning in detail to FIG. 1, network architecture 100 is shown that may be used to implement the various adaptive aspects of the present invention. Plural computer workstations, such as 1, 2, 3 and 4 are connected to the local area network (LAN) 5, directly or via Bridge 11, Router 9 or Hub 10. Workstations 1, 2, 3 and 4 may each comprise a standard workstation PC. Other workstations, such as Unix workstations may also be included in the network and could be used in conjunction with workstations 1, 2, 3 and 4.

A PDA 8 operating under the operating system designated as Pocket PC or Pocket PC 2002 1(Microsoft Corporation®), with a wireless interface card compatible with wireless LAN (WLAN) standards, such as 802.11b, is coupled to LAN 5. PDA 8 can communicate with networked peripherals, such as 6 and 7. PDA 8 can also communicate with networked workstations 1,2,3 and 4, and Bridge 11, Router 9 and Hub 10.

One skilled in the art can appreciate that the foregoing devices are coupled to the LAN 5 through a LAN interface (not shown) such as an Ethernet interface 10 Base-2 with a Coax connector or 10 Base-T with an RJ-45 connector. The present invention may also use LAN Token-Ring architecture.

Typically, a LAN serves a localized group of users within the same building. As users become more remote from one another, for example, in different buildings, a wide area network (WAN) (not shown) may be created. In one aspect, the present invention may be adapted to operate with a WAN.

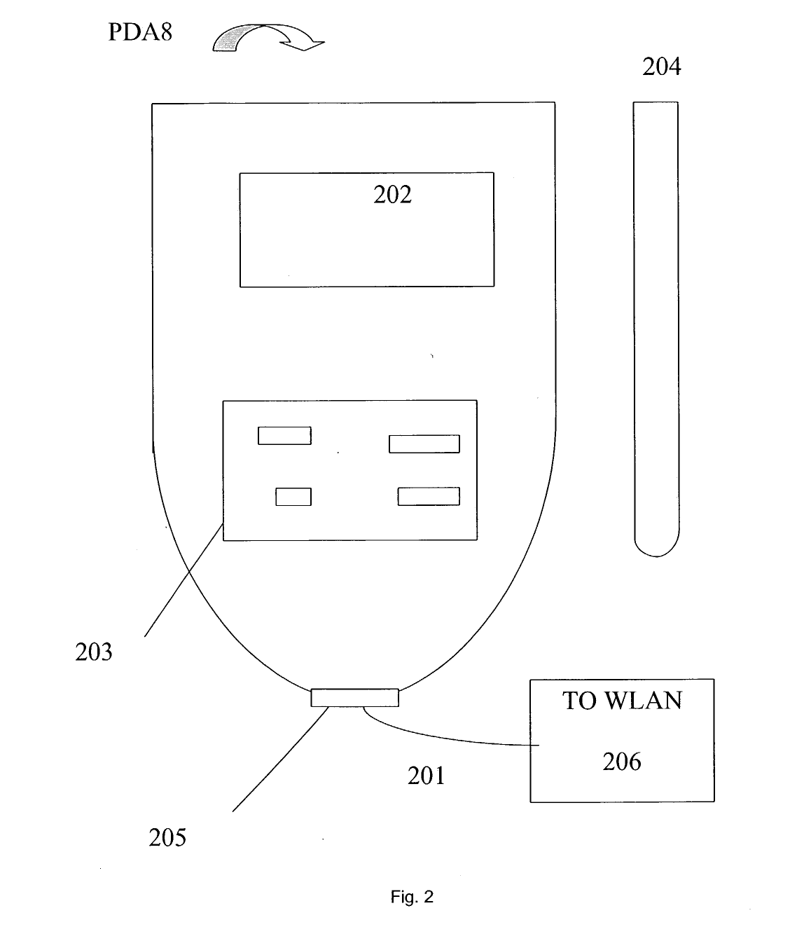

LAN 5 supports data packets transmitted according to the TCP/IP network protocol (IP-packets). Each of these packets includes a destination field, a source field, a data field, a field indicating the length of the data field, and a checksum field. It is noteworthy that the present invention is not limited to TCP/IP but may be implemented using other communication protocols as well. FIG. 2 is an outward view showing a representative handheld device (PDA 8) embodying the present invention. PDA 8 may operate under various operating systems, e.g., Pocket PC formerly called Windows CE (Microsoft Corporation®), or Palm OS (Palm Computing, Inc.®). PDA 8 includes a display area 202 that may be used as a writing tablet or a touch screen for inputting commands and/or data, and plural buttons 203 that are used to operate PDA 8. A stylus 204 may be used to write in display area 202, and also, content (not shown) may be input using one or more of the plural buttons 203.

PDA 8 interfaces with WLAN (device 206) via interface 205 and connection 201. The WLAN is coupled to LAN 5.

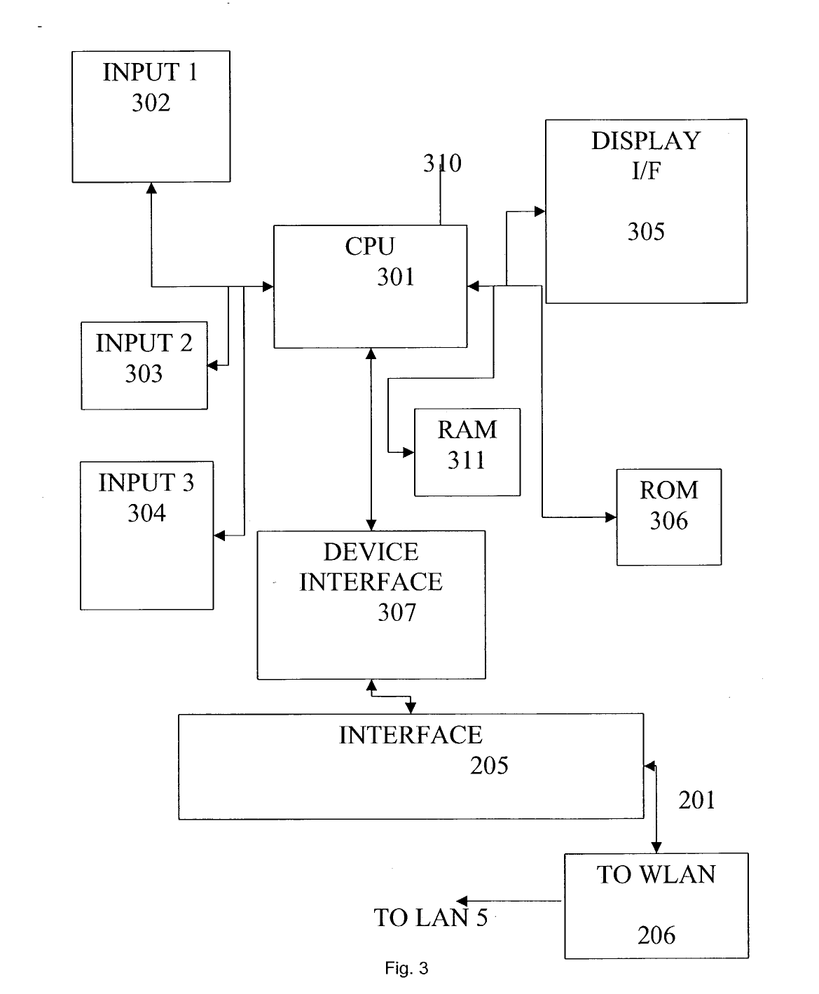

FIG. 3 is a block diagram showing the internal functional architecture of PDA 8. As shown in FIG. 3, PDA 8 includes central processing unit (“CPU”) 301 that interfaces with various components described below and is used for executing computer-executable process steps including those discussed below.

CPU 301 may receive input from various sources including a touch screen 202 via a touch screen interface 302, plural buttons 203 via button interface 303; and other external sources, e.g., keyboard (not shown) via interface 304.

CPU 301 also interfaces with device interface 307 that allows handheld device PDA 8 to be connected to a WLAN via interface 205. In another aspect PDA 8 may have a dedicated wireless port allowing WLAN connectivity. CPU 301 also interfaces with a display interface 305 for displaying data in display area 202.

A random access main memory (“RAM”) 311 also interfaces with CPU 301 to provide CPU 301 with access to memory storage. When executing stored computer-executable process steps CPU 301 stores those process steps in RAM 311 and executes the stored process steps out of RAM 311.

Read only memory (“ROM”) 306 is provided to store invariant instruction sequences such as start-up instruction sequences or basic Input/output operating system (BIOS) sequences. ROM 306 may also store basic programs, e.g., address book, calendar, memo pads and the operating system.

Also shown in FIG. 3 is an infrared port 310 that provides a cable-less connection between PDA 8 and other peripherals.

In one aspect of the present invention, PDA 8, uses a program called “PDAlert” that discovers and monitors networked devices (peripherals such as Printer 7; Fax 6; Bridge 11; Router 9 and Hub 10 and systems such as Workstations 1, 2, 3 and 4).

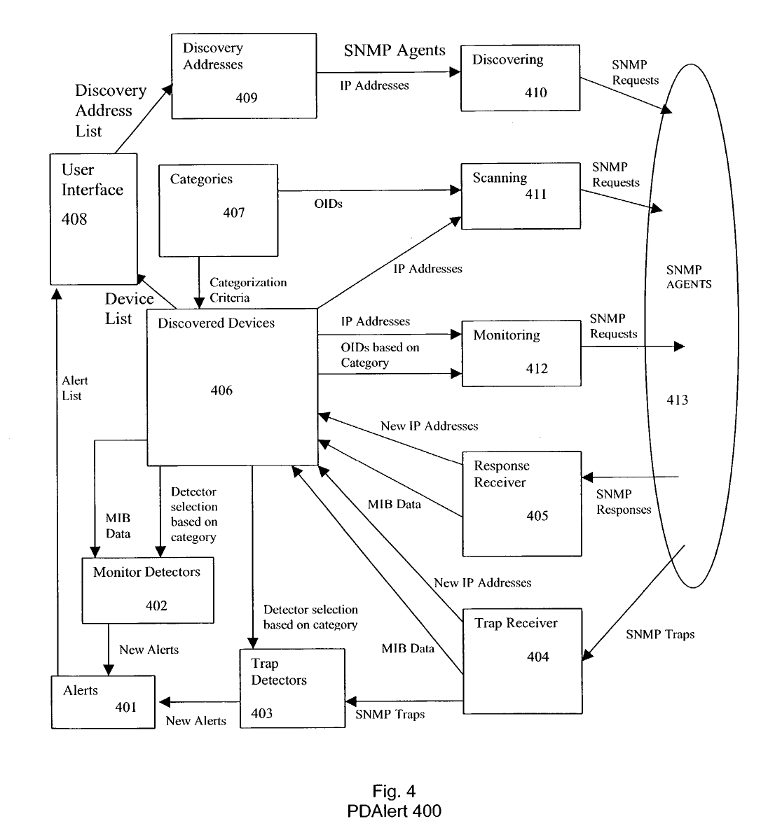

FIG. 4 is a top-level block diagram of a system 400 (also referred to herein as “PDAlert 400”) that allows discovery, categorization and monitoring of various network devices coupled to LAN 5. PDAlert 400 includes a user interface 408 that receives alerts from alert module 401.

PDAlert 400 also includes a discovery module 410 that discovers network devices based on discovery addresses 409 using SNMP requests.

Scanning module 411 scans networked devices for categorization, while monitoring module 412 monitors the network devices.

A response receiver module 405 is coupled to a discovered device module 406 that provides a device list of discovered devices to PDA 8.

PDAlert 400 also includes a trap receiver 404 that passes SNMP traps to a trap detector 403 that detects the traps and adds new alerts to the list of alerts 401 and ultimately to user interface 408.

It is noteworthy that the invention is not limited to the foregoing modules. PDAlert 400 may have more sub-modules or have all the modules integrated in various ways.

To discover and monitor a network device, PDA 8 must know the category of the network device. The following describes a discovered device and a device category.

Discovered Device 406

Discovered devices 406 represent the devices that are discovered on a network, e.g., networked peripherals 6 and 7, networked workstations 1,2 3 and 4, Bridge 11, Router 9 and Hub 10, as shown in FIG. 1. Typically, every discovered device has a unique network address.

Each discovered device 406 contains information that has been received from networked devices, referred to herein as “data store”, as discussed below. The information includes responses to broadcasts made to discover the device, response(s) to requests made for information needed to categorize the device, response(s) to requests made for monitoring, and unsolicited information received from networked devices. Discovered devices 406 store previous data samples to permit detection of any change in the data store in addition to the current value of data. The foregoing information may be stored as OID values. It is noteworthy that the invention is not limited to storing the foregoing values as OIDs, other formats may be used to implement the various adaptive aspects of the present invention.

Device Categories

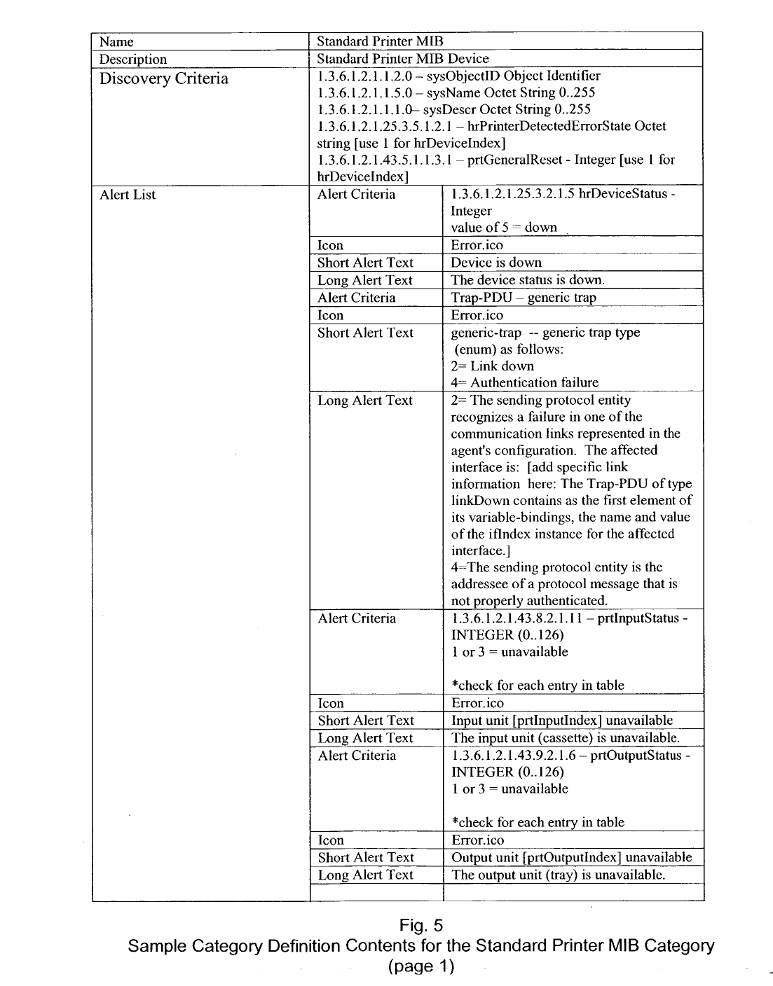

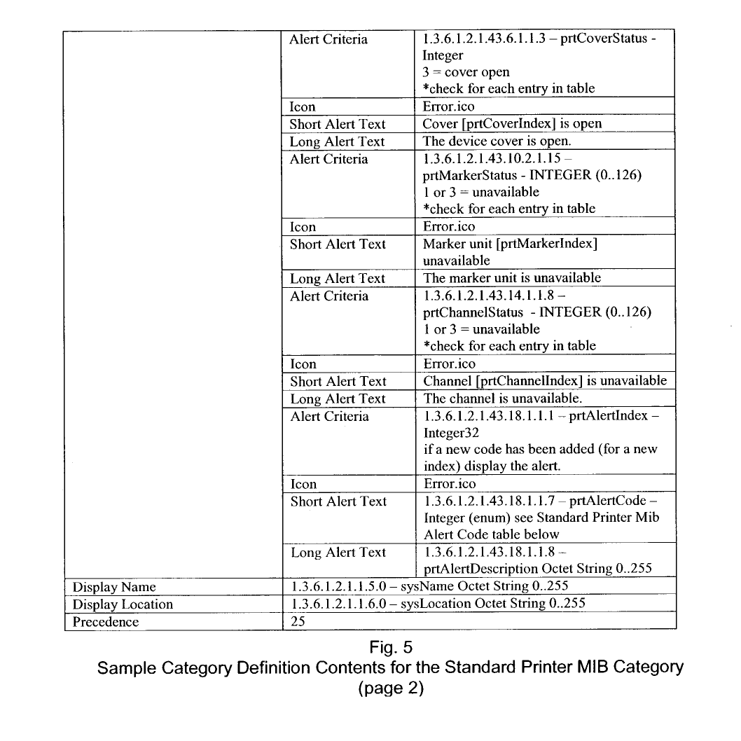

A device category represents a kind of device. For example, a category could represent all standard printers, or it could represent a type of printer. A category includes logic (as data objects and procedures) to request information from a device to support categorization, determine categorization, determine specific attributes of a member of the category, request information for detecting alerts, and detecting alerts. In one aspect of the present invention PDAlert 400 uses a list of OIDs encapsulated as protocol data units (“PDUs”) to acquire device information. FIG. 5 shows an example of sample category definitions for Standard Printer MIB category (available from Internet Engineering Task Force (IETF)). LAN 5 via WLAN 206 may use category definitions as specified in FIG. 5 (as an example for the category definition for Standard Printer MIB devices), to distinguish which discovered devices 406 belong to the category, determine the objects to discover devices in the category and determine the criteria for gathering alert information.

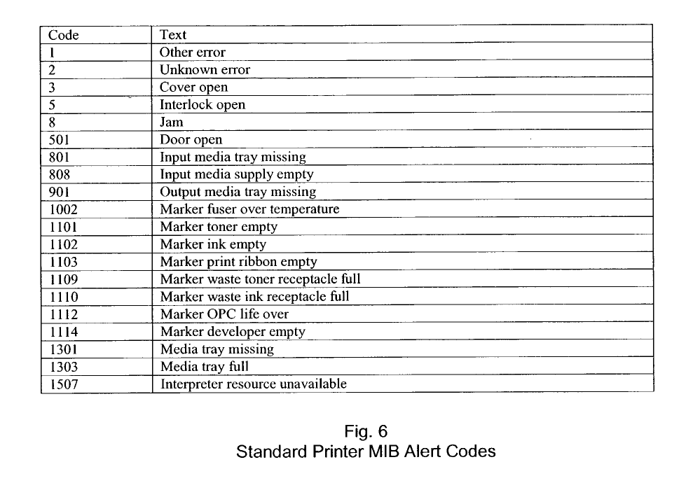

Alert information includes the objects to attain this information, the icon to display the alert, a short description of the alert and a detailed description of the alert. FIG. 6 shows an example of plural alert codes that may be used by PDAlert 400 to implement the various aspects of the present invention.

The invention further uses category definitions to determine the name to display for the discovered device 406, determine the location of the discovered device 406 and determine the precedence of the category as specified in FIG. 5.

In one aspect of the present invention PDAlert 400 is used for scanning, categorizing, monitoring, and response handling of network devices, as described below.

Scanning

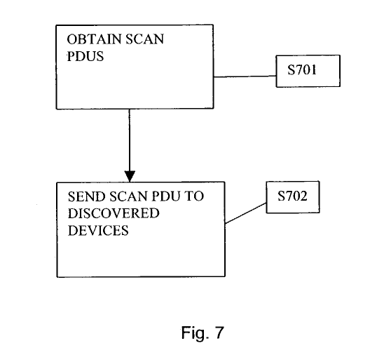

Scanning is used to retrieve information from a networked device to determine the category of the device. Because scanning doesn't assume the category of a device it makes requests for all possible categories. FIG. 7 illustrates executable process steps that allow PDA 8 to scan a networked device.

Turning in detail to FIG. 7, in step S701, PDA 8 acquires a list of all scan PDUs for each category 407. Scanning module 411 obtains the OIDs for all the categories 407. Scan PDUs include OIDs to determine if a device belongs to particular category. Scan PDUs also include other OIDs to determine device attributes, for example, the name of a device may be retrieved from a different OID for a printer versus a router.

In step S702, the scan PDUs are sent to all discovered devices 406.

Thereafter, when responses are received the process moves to step S801 to determine the category of the devices.

Categorization

The data store of a discovered device is independent of the requests that store the data. Hence it is possible at any point in time to determine the category of a discovered device. A category object contains logic to determine if a device is one of its members. It determines the category by examining the data store of the discovered device looking for the existence of specific pieces of data, specific values of specific pieces of data, or a specific relationship between specific pieces of data. Even though more than one category may claim the same device as one of its members, for practical purposes a device belongs to only a single category. For example, in the case of Generic Printers and Laser Printers, the membership rules for Generic Printers are more lax than for Laser Printers. This results in the characteristic that all Laser Printers are Generic Printers, but not all Generic Printers are Laser Printers. The Laser Printer category is more specialized than the Generic Printer category.

To determine the specialization of a category each category is given a precedence value (for example, as shown Standard Printer MIB precedence definition in FIG. 5). The higher the precedence value of a category the more specialized the category. When a device is claimed as a member of more than one category it is considered to belong to the most specialized category, the one with the highest precedence. When determining the category of a device it is desirable to avoid considering every category. This is avoided by putting the categories into a list sorted by descending precedence. The most specialized categories are the earliest in the list. When determining the category of a device each category in the list is considered until the first category is found that will claim the device as a member. There is one category that will claim any device as a member. It has the lowest precedence and so is always last in the list. It guarantees that all devices will have a category.

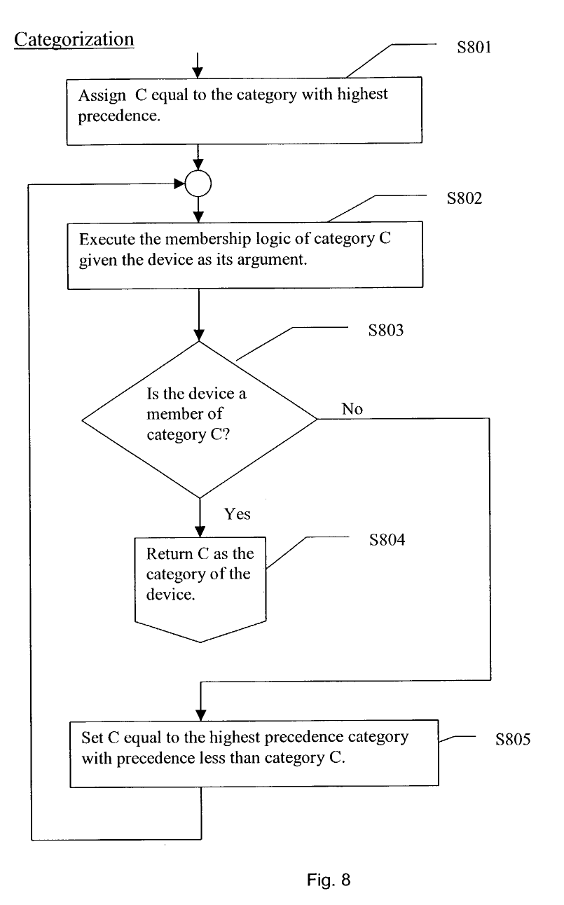

FIG. 8 illustrates the categorization process. In step S801, the category of highest precedence is assigned. In step S802, the membership logic of the category is executed.

In step S803, the process checks if the device is a member of that category. If that is true then in step S804 that category is returned as the category of the device. If it is not then in step S805, the category of next lower precedence is considered. This procedure continues until a category is found that will claim the device as a member. Because the category with the lowest precedence will claim any device as a member, the loop terminates at that point, if not sooner.

Monitoring 412

The primary category-specific activity is monitoring. The purpose of monitoring is to detect alerts specific to a category. For example, a router won't be out of paper, but it might receive a route update. Likewise, a printer might be out of paper, but it will never be on battery. A UPS might be on battery, but it won't receive a route update. As part of the logic in a category is a list of requests to detect alerts. PDAlert 400 uses these requests as PDUs containing lists of OID values. Again it is noteworthy that the invention is not limited to using OID values, any other format may be used.

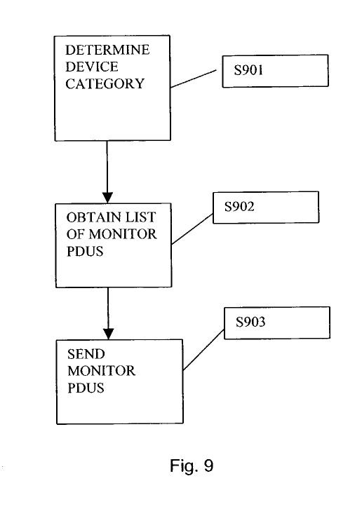

FIG. 9 shows executable process steps that assist PDA 8 to monitor network devices using monitoring module 412.

In step S901 the process determines the device category, as described above.

In step S902, monitoring module 412 acquires a list of PDUs for the category from the discovered device module 406.

In step S903, monitoring module 412 sends the list of PDUs to the device. The same set of steps S901-S903 is carried out for each discovered device.

Response Handling 404 and 405

The responses for each device are stored in the data store for that discovered device. When any responses or asynchronous data are received from a device they are stored in the discovered device's data store. In PDAlert 400, asynchronous data comes from SNMP Traps. This could be extended to include any kind of sent data.

Alert detection logic 402 and 403 for the category of the device is used to detect any alerts that have occurred. Previous samples in the device may be examined or updated to support the ability to detect changes in values in addition to the values themselves. When a value indicates an alert condition, an alert is produced only if the value differs from the previous value. Once the check is made the current value is copied over the previous value. This insures alerts are only generated when a value changes.

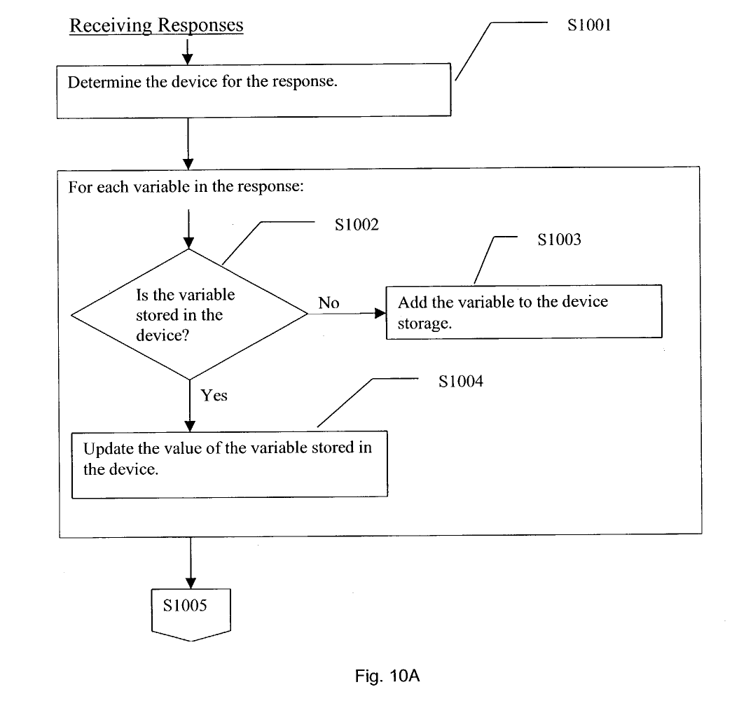

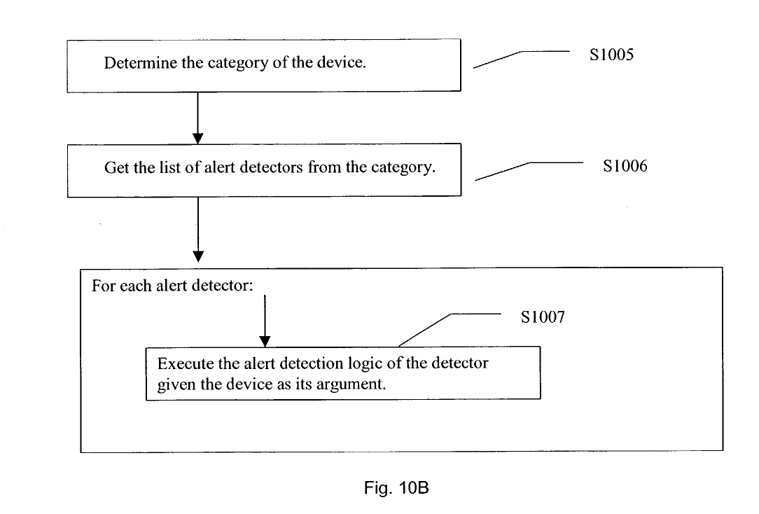

The procedure for handling responses is illustrated in FIGS. 10A and 10B.

In step S1001, the device associated with a response is determined from the IP address of the sender of the response. Each variable (an Object Identifier and a value) in the response is stored in the data store of the discovered device.

In step S1002, the response receiver 405 or the trap receiver 404 determines if the variable is already stored in the discovered device 406. If the variable is not stored in the discovered device 406, then in step S1003, the variable is stored. If it is already stored in the discovered device 406 then the stored value in the discovered device 406 is updated in step S1004. Once all variables in the response have been processed then the category of the device is determined S1005.

The category provides the set of alert detectors (as defined in FIGS. 5 and 6 for Standard Printer MIB devices as an example) applied to the discovered device 406. Each alert detector contains logic that examines a specific set of variables and produces alerts 401 if the conditions match its criteria.

In step S1005, the process determines the category of the discovered device 406.

In step S1006, the list of alert detectors is obtained for the category.

In step S1007, alert detection logic is executed with the device as its argument.

While the present invention is described above with respect to what is currently considered its preferred embodiments, it is to be understood that the invention is not limited to that described above.

What is claimed is:

1. A method for identifying and categorizing managed network devices and systems (devices) using a handheld device, comprising:
scanning the devices to retrieve information to facilitate categorization of the device.

2. The method of claim 1, further comprising:
categorizing the devices in order of precedence.

3. The method of claim 1, further comprising:
monitoring alerts for the devices specific to a category.

4. The method of claim 1, further comprising:
handling the responses of the devices.

5. The method of claim 1, wherein every discovered device is sent a scan PDU for every category.

6. The method of claim 2, wherein starting with the category of highest precedence the membership logic of that category is matched with device data, and if it matches, the device is placed in that category.

7. The method of claim 3, wherein during monitoring every discovered device is, sent every PDU from a monitor PDU list for the category of the device.

8. The method of claim 4, wherein handling of the responses include storing a variable of the response if the same is not stored in the device and if it is already stored then updating the value stored in the device.
